(19) United States
(12) Patent Application Publication
(10) Pub. No.: US 2013/0144734 A1
(43) Pub. Date: Jun. 6, 2013

(54) MONEY TRANSFER SYSTEM USING PRE-FUNDED ESCROW

(71) Applicants: Richard Scott Perkins, Meridian, ID (US); Kurt Thams, Santa Cruz, CA (US); Michael Tibbott, Mountain View, CA (US); Barry Donald McKeon, Felton, CA (US); John Paul Minor, Brick, NJ (US); Jim Given, Oakland, CA (US)

(72) Inventors: Richard Scott Perkins, Meridian, ID (US); Kurt Thams, Santa Cruz, CA (US); Michael Tibbott, Mountain View, CA (US); Barry Donald McKeon, Felton, CA (US); John Paul Minor, Brick, NJ (US); Jim Given, Oakland, CA (US)

(21) Appl. No.: 13/312,835

(22) Filed: Dec. 6, 2011

(51) Int. Cl. G06Q 20/20; G06Q 20/40

(52) U.S. Cl. 705/18; 705/16

(57) ABSTRACT

Disclosed herein are systems and method for facilitating money transfer transactions between a sender and a recipient. In general, the systems and methods include: (a) a point-of-service terminal (POS) receiving an initiation payment from a sender; (b) a pre-funded account that receives replenish payments from the POS; (c) a money transmitter terminal that receives a funding payment from the pre-funded account, and provides a fulfillment payment to a recipient; and (d) a centralized service provider linking the POS, the pre-funded account, and the money transmitter. In operation, the centralized service provider (1) receives presentment data, from the POS, indicating that the sender has provided the initiation payment at the POS, (2) provides a computerized notification to the money transmitter, instructing the money transmitter to provide the fulfillment payment to the recipient, and (3) facilitates the replenishment of the pre-funded account.

### SUMMARY

Disclosed herein are systems and method for facilitating money transfer transactions between a sender and a recipient. In general, the systems and methods include: (a) a point-of-service terminal (POS) receiving an initiation payment from a sender; (b) a pre-funded account that receives replenish payments from the POS; (c) a money transmitter terminal that receives a funding payment from the pre-funded account, and provides a fulfillment payment to a recipient; and (d) a centralized service provider linking the POS, the pre-funded account, and the money transmitter. In operation, the centralized service provider (1) receives presentment data, from the POS, indicating that the sender has provided the initiation payment at the POS; (2) provides a computerized notification to the money transmitter, instructing the money transmitter to provide the fulfillment payment to the recipient; and (3) facilitates the replenishment of the pre-funded account.

### BRIEF DESCRIPTION OF THE FIGURES

The accompanying drawings, which are incorporated herein, form part of the specification. Together with this written description, the drawings further serve to explain the principles of, and to enable a person skilled in the relevant art(s), to make and use the claimed systems and methods.

FIG. 1 is a high-level flow process chart illustrating the relationships between the parties that partake in the presented systems and methods.

FIG. 2 is a high-level flow process chart illustrating a method for facilitating money transfer transactions, in accordance with one embodiment presented herein.

FIG. 3 is a flow process chart illustrating an aspect of the system and method of FIG. 2.

FIG. 4 is a flowchart illustrating an embodiment presented herein.

FIG. 5 is a flow process chart illustrating an implementation of the systems and methods presented.

FIG. 6 is a flow process chart illustrating an implementation of the systems and methods presented.

FIG. 7 is a flow process chart illustrating an implementation of the systems and methods presented.

FIG. 8 is a schematic drawing of a computer system used to implement the methods presented herein.

### DETAILED DESCRIPTION

Embodiments of the present invention generally relate to systems and methods for facilitating money transfer transactions between a money sender and a money recipient. For example, the present invention provides a sender a means for conducting a money transfer transaction to a recipient, via a remote point-of-service or point-of-sale (POS) terminal. Further, the present invention provides a cloud-based computing solution that allows any third-party POS to serve as a receiving agent for a licensed and regulated money transmitter, under the existing money transfer regulatory framework. The present invention is related to the disclosures provided in co-pending and co-owned U.S. patent application Ser. Nos. 13/123,067; 13/087,271; and 13/175,657, the disclosures of which are herein incorporated by reference in their entirety, with the exception of term definitions that contradict any term definitions provided herein.

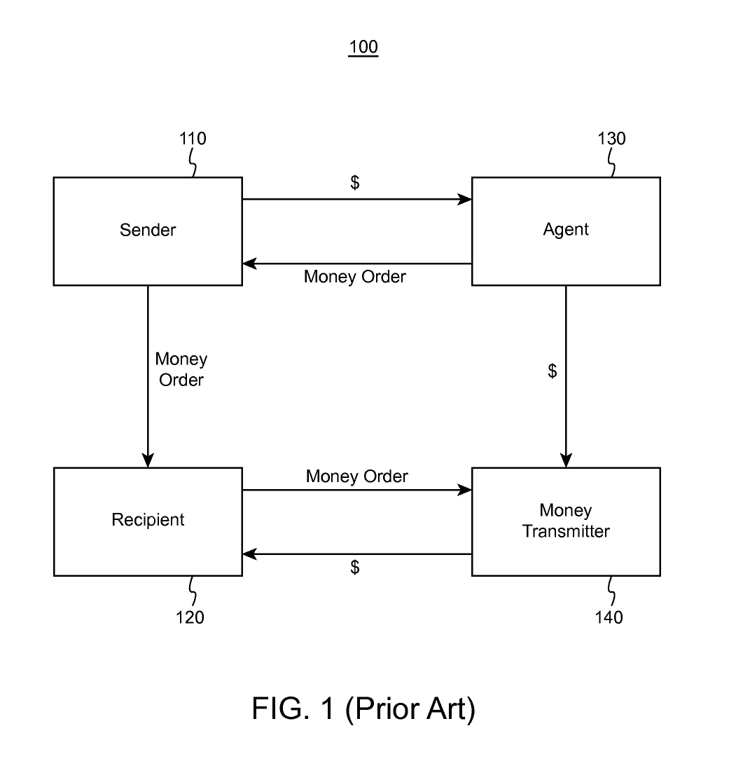

FIG. 1 is a high-level flow process chart illustrating the relationships between the parties that partake in the presented systems and methods. The terms “sender,” “consumer,” “customer,” and “end-user” are used interchangeably herein, and are generally intended to include the person or entity that provides an initiation payment to begin a money transfer to a recipient. The “recipient” is the person or entity ultimately receiving the corresponding funds from the sender. The terms “point-of-sale,” “point-of-sale terminal,” “POS,” “POS terminal,” “point-of-service,” and “agent” are used interchangeably herein, and are generally understood to be the entity performing the function of receiving an initiation payment from a sender, and serving as a receiving agent for a licensed money transmitter. The licensed money transmitter (also referred to as “licensee,” “money transmitter,” or “merchant”) is the person or entity authorized to transmit money from a sender to a recipient under existing money transfer regulations. The terms “service provider” and “payment processor” are used interchangeably herein.

FIG. 1 shows a schema 100 for a money transfer transaction, in accordance with previously available means. As shown in FIG. 1, a Sender 110 initiates a money transfer by providing an initiation payment to an Agent 130. In return for the initiation payment, Agent 130 issues a currency instrument, such as a Money Order, in the name of Recipient 120. The Money Order is then either provided directly to a Recipient 120, or forwarded to a Money Transmitter 140 for redemption by Recipient 120. When Recipient 120 presents the Money Order (or identification for the redemption of the Money Order) to Money Transmitter 140, the corresponding funds are distributed to Recipient 120 as a fulfillment payment. The process of FIG. 1 lacks flexibility in that Sender 110 is forced to submit an initiation payment only at pre-authorized receiving agents (e.g., Agent 130) of Money Transmitter 140. The process of FIG. 1 also lacks the immediacy of availability of funds to the recipient.

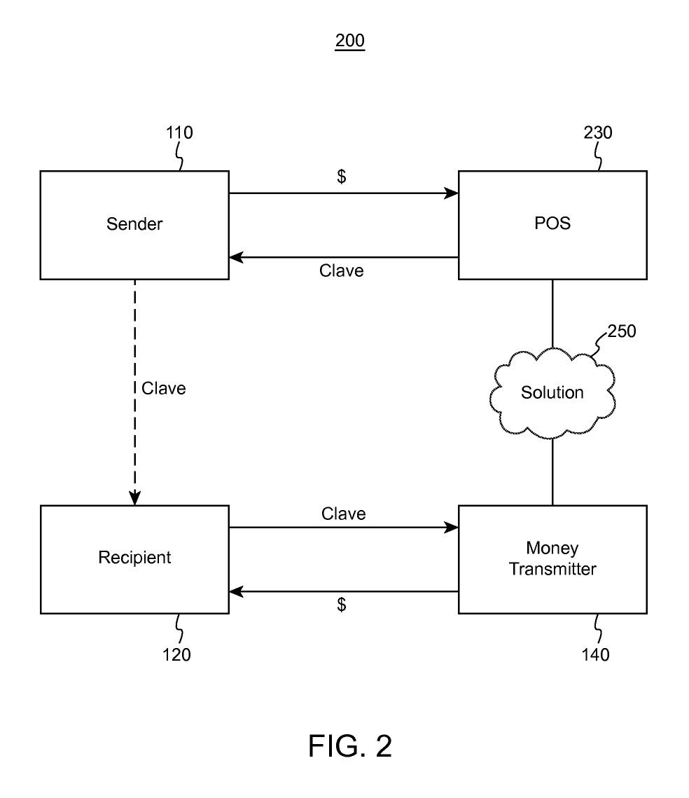

FIG. 2 is a high-level flow process chart illustrating a system and method 200 for facilitating money transfer transactions. Unlike the schema 100 of FIG. 1, system 200 allows any POS 230 to replace the function of a pre-authorized receiving agent (e.g., Agent 130). More specifically, a cloud-based computing solution 250 is provided as a payment processor to allow Money Transmitter 140 to work with any third-party POS 230 (or POS controlling entity); such as a retail outlet, an ATM, a kiosk, a service agent, a money receiving office, or any equivalents or combinations thereof. Cloud-based solution 250, as described in more detail below, is necessary because without said solution, the linear transfer of funds between Sender 110, POS 230, and Money Transmitter 140 would be too slow to meet existing money transfer regulations. Under current money transfer regulations, for example, Money Transmitter 140 must account for Sender's 110 funds when the money transfer transaction is initiated at POS 230. Money Transmitter 140 must therefore have said funds available for redemption by Recipient 120 within hours of the money transfer initiation. Due to the complexities in timing protocols, banking hours, banking closures, and other commercial factors, it is difficult (if not impossible) for Money Transmitter to work with a third-party POS 230 systems without some intermediary solution.

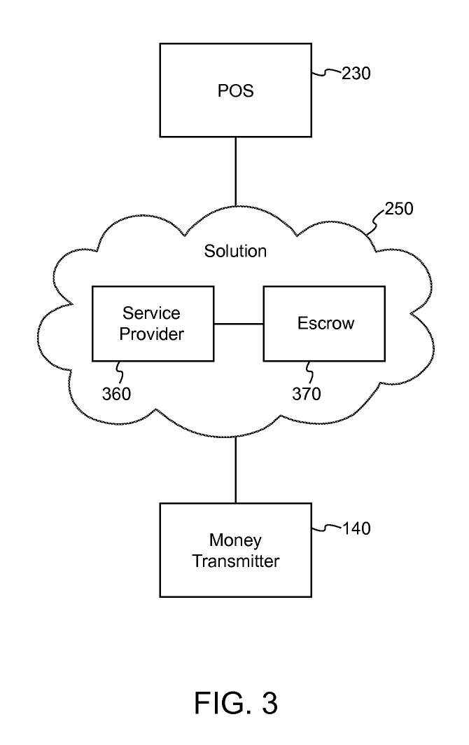

FIG. 3 is a flow process chart illustrating an aspect of the system and method illustrated in FIG. 2. As shown in FIG. 3, cloud-based computing solution 250 includes at least a Service Provider 360 and an Escrow account or service 370. In practice, POS 230 pre-funds Escrow 370. The pre-funded account balance is carried on Money Transmitter's 140 accounting as funds payable to POS 230. As such, the pre-funding of Escrow 370 serves as a controlled acceleration of funds to Money Transmitter 140, insures the solvency of Money Transmitter 140 upon redemption by Recipient 120, and allows Money Transmitter 140 to partner with any third-party POS 230 for receiving funds from Sender 110. While Escrow 370 may be maintained or managed by Service Provider 360 or a third-party, the use of the term “escrow” should not be interpreted to require a third-party or intermediary. For example, in one embodiment, Escrow 370 is an account held and/or managed by Money Transmitter 140 and pre-funded by POS 230.

In one embodiment, Sender 110 provides an initiation payment to POS 230. In return, POS 230 provides Sender 110 with a unique identification code, such as a “clave,” as the term is known in the art. Sender 110 then provides the clave to Recipient 120. After receiving the clave, Recipient 120 can provide the clave (and any other identification data) to Money Transmitter 140. Because Money Transmitter 140 has been accelerated funds via Escrow 370, Money Transmitter 140 can immediately distribute a fulfillment payment to Recipient 120, without violating its solvency or existing money transfer regulations.

As such, POS 230, Solution 250, and/or Money Transmitter 140 serve as intermediaries between Sender 110 and Recipient 120, allowing Sender 110 to transfer money to Recipient 120 in cash (or cash equivalents) via any POS terminal. In one embodiment, each party serves a stand-alone function within system 200. However, in an alternative embodiment, Solution 250, Service Provider 360, and/or Escrow 370 may be incorporated into, or be a functional unit of, Money Transmitter 140 and/or POS 230. Further, Money Transmitter 140 may be any type of merchant, seller, or retailer. POS 230 may be a local retailer (e.g., “local” relative to Sender 110), ATM, kiosk, or other cash-exchange terminal, intermediary, or equivalent thereof.

In order for system 200 to be commercially viable, the systems and methods presented generally include the process steps of: (a) staging a transaction between the money transmitter and the sender; (b) tokenizing the transaction by linking one or more transaction instructions to a token ID; (c) providing the sender with the token ID, wherein the sender can then present the token ID and a payment to a POS terminal; (d) receiving confirmation that the sender has presented, to a POS terminal, the token ID and an initiation payment in accordance with the one or more staged transaction instructions; (e) notifying the money transmitter that the sender provided the initiation payment to the POS terminal; and (f) settling the transaction between the POS terminal and the money transmitter. Related concepts and embodiments are discussed in the above-identified applications (i.e., U.S. patent application Ser. Nos. 13/123,067; 13/087,271; and 13/175,657), which have been incorporated by reference.

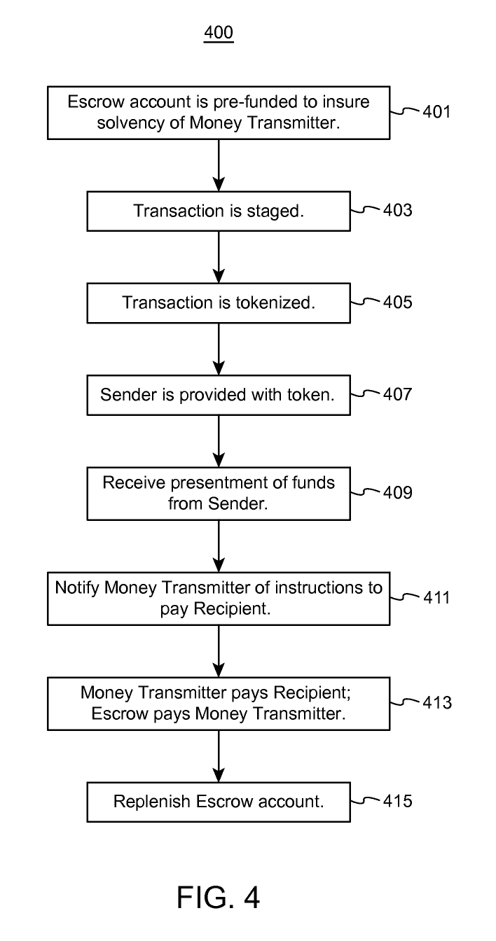

FIG. 4 is a flowchart illustrating a method 400 for transferring money between a sender and a recipient, in accordance with one embodiment presented herein. In step 401, an escrow account is pre-funded to insure the solvency of a money transmitter, upon redemption by the recipient. In step 403, the money transfer transaction is staged. In one embodiment, for example the money transfer transaction is staged by Money Transmitter 140. Alternatively, the transaction can be staged by Service Provider 360. In one embodiment, Service Provider 360 “stages” a transaction by simply maintaining a database with previously staged transactions (e.g., transactions staged by Money Transmitter 140).

In practice, Money Transmitter 140 and/or Service Provider 360 stages the money transfer transaction by linking a set of one or more transaction instructions to Sender 110. The transaction instructions may vary, but generally include instructions on what actions (e.g., initiation payments) need to be performed by Sender 110 in order for Money Transmitter 140 to provide Recipient 120 with an agreed upon fulfillment payment. In one embodiment, the transaction is staged and maintained on a database by Money Transmitter 140, and access to (or a copy of) the database is provided to Service Provider 360.

In step 405, the staged transaction is “tokenized” (by Money Transmitter 140 and/or Service Provider 360). For example, the staged transaction can be tokenized by linking the set of one or more staged transaction instructions to a token ID. The token ID is then provided to Sender 110, in step 407. The token ID may be provided to Sender 110 directly from Money Transmitter 140, Service Provider 360, or indirectly through POS 230. The token ID may be provided in a form such as: a printout slip or receipt, a transaction card, a printed barcode, a pin number, a programmed near-field communication chip, a mobile device prompt, a mobile device barcode, an e-mail, a quick response code, and any combination or equivalent thereof. The token may be in electronic format or may be a physical item that the sender can pick up at a POS terminal or other retail location. In an alternative embodiment, a single token ID can be linked to multiple staged transactions and/or multiple money transmitters. (The terms “token,” “token ID,” “unique payment identifier,” and “PID” are used interchangeably herein.)

The tokenizing of staged transactions, inter alia, facilitates integration between a money transmitter's internal system and records, and a POS terminal system, without compromising security information for the money transmitter and/or the sender. The tokenizing of the staged transaction also allows for a “standardization” of the process. As such, a sender can use one or more token IDs to conduct transactions with one or more money transmitters, and vice-versa.

When Sender 110 is ready to make an initiation payment, Sender 110 presents the token ID to POS 230, along with an appropriate payment. At POS 230, the token ID serves as a means of linking the Sender's 110 payment to the one or more transaction instructions.

In step 409, Sender 110 presents the token ID and payment to POS 230, the token ID is used to route the presentment information to Service Provider 360. The token ID is preferably configured to seamlessly integrate with the POS terminal's cash-exchange system. As such, a clerk or employee at the POS terminal can receive the presentment as a transaction typical to the POS terminal (i.e., without any specialized instructions, training, equipment, etc.). For example, in one embodiment, the token ID is a barcode that can be presented to a barcode scanner at the POS terminal. The token ID may include routing information such that the POS terminal automatically communicates and routes the presentment information to Service Provider 360.

Service Provider 360 may then validate that the presentment was in accordance with the transaction instructions linked to the token ID (e.g., sender paid the appropriate amount; sender made payment prior to expiration of the staged transaction; etc.). If Sender's 110 payment is in accordance with the transaction instructions linked to the token ID, then Service Provider 360 notifies Money Transmitter 140 that a payment has been made, in step 411. Service Provider 360 may also take additional steps to validate the presentment; such as, for example, communicating with Money Transmitter 140 to ensure the staged transaction is still valid; confirming Escrow 370 is sufficiently funded to complete the transaction; confirming Money Transmitter 140 has the funds/resources necessary to provide the fulfillment payment; confirming that the initiation payment amount is still acceptable to Money Transmitter 140; etc.

Money Transmitter 140 then provides a fulfillment payment to Recipient 120, in step 413, and Service Provider 360 notifies Escrow 370 to provide a funding payment to Money Transmitter 140. Finally, Service Provider 360 settles the money transfer transaction by providing a replenish payment to Escrow 370, either directly or indirectly through POS 230, in step 415. For example, in one embodiment, Service Provider 360 replenishes Escrow 370, and then settles with POS 230 at a later date. Further, Service Provider 360 may adjust the amounts received and/or distributed in accordance with a contractual agreement between the parties.

As used herein the phrases “receive funds” and/or “distribute funds” do not require direct communications/transfers between individual entities. Settlement also does not require the actual “touching” of funds. For example, as used herein, to “settle the transaction” means to: transfer funds; direct funds; provide an interface for the transfer of funds; and/or otherwise provide the necessary instructions to make sure the funds are properly directed from one entity to another. Further, to “settle the transaction” includes communications/transfers with any and all centralized or hierarchical entities that receive funds from individual points-of-sale terminals at the closing/settling of an individual terminal.

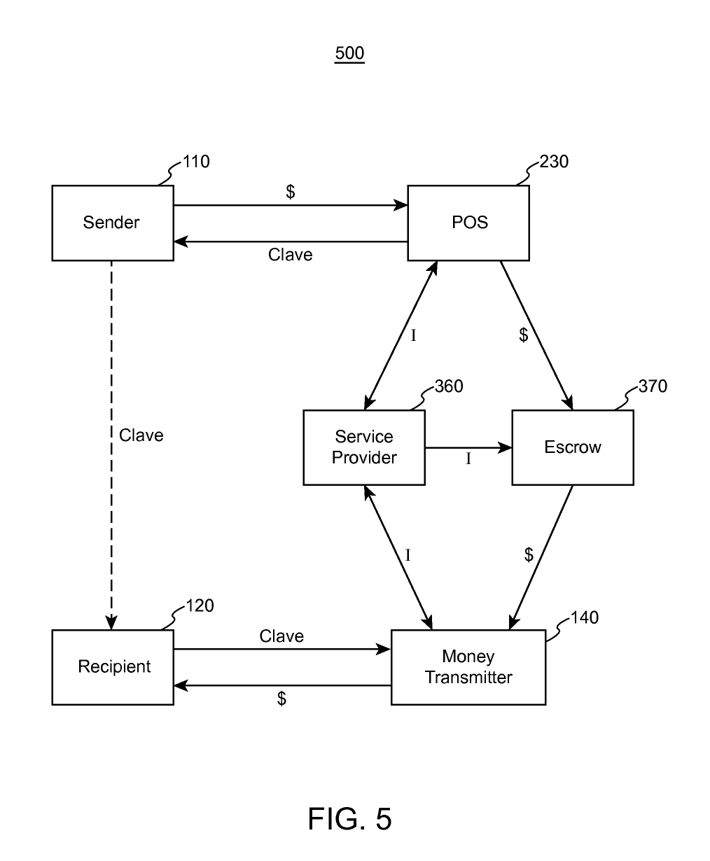

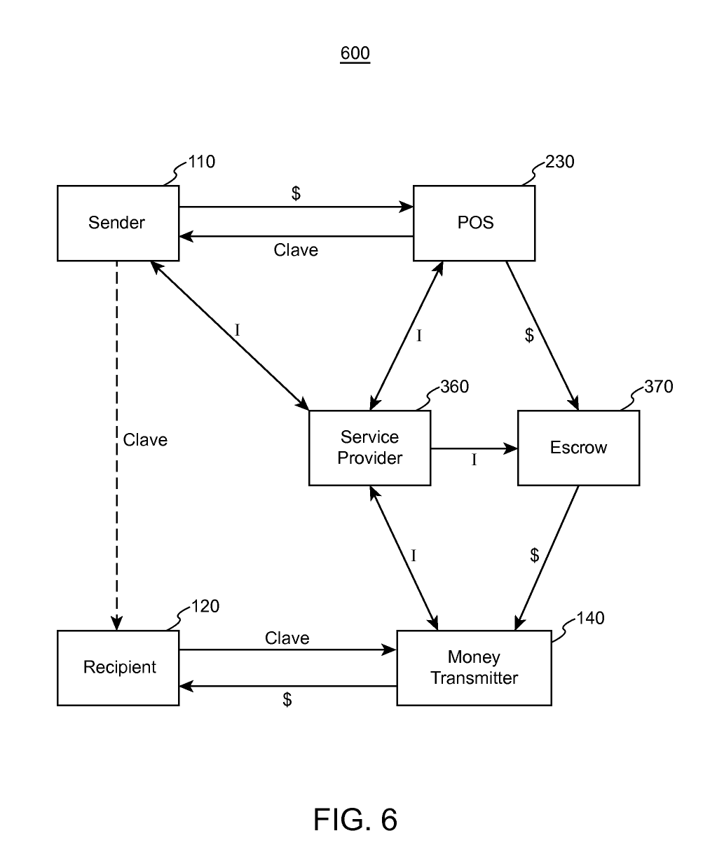

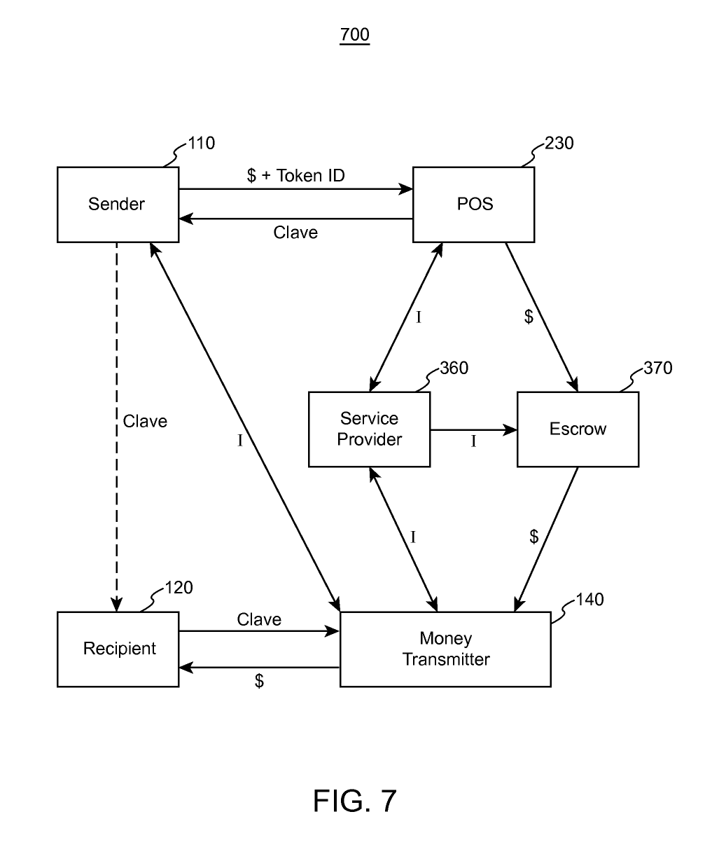

FIG. 5 is a flow process chart illustrating an implementation 500 of the systems and methods presented. In practice, the lines in FIG. 5 (as well as FIGS. 6 and 7) represent user interfaces and/or application programming interfaces (APIs) for the transmission of information, data, instructions, funds, etc. Dollar sign symbols ($) are intended to represent that at least money is being provided. Letters “I” are intended to represent that at least instructions are being provided.

In FIG. 5, Sender 110 provides POS 230 with an initiation payment for a money transfer to Recipient 120. POS 230 provides Sender 110 with a clave, which is then provided to Recipient 120. When recipient 120 provides the clave (and any other necessary identification information) to Money Transmitter 140, Money Transmitter 140 then provides a fulfillment payment to Recipient 120.

In order for said money transfer transaction to meet the transfer velocity prescribed by the existing money transfer regulations, the functions of Service Provider 360 and Escrow 370 are provided as intermediaries between POS 230 and Money Transmitter 140. POS 230 is linked to Service Provider 360 to at least notify Service Provider 360 that Sender 110 has provided an initiation payment. Upon confirmation that Sender 110 has provided an initiation payment, Service Provider 360 notifies Money Transmitter 140 to provide a fulfillment payment to Recipient 120, and notifies Escrow 370 to provide a funding payment to Money Transmitter 140. Service Provider 360 then instructs POS 230 to distribute a replenish payment (or distributes the funds directly) to Escrow 370. In practice, replenish payments are wired on the following business day with funds corresponding to the transactions that were initiated on the prior business day(s). Service Provider 360 may also provide each party with a summary of all the transactions that have been staged, received initiation, fulfilled, and/or replenished over a given transaction period. Replenish funds should become immediately available and payable to Money Transmitter 140 after being received by Escrow 370. In one embodiment, Service Provider 360 also confirms that the Escrow 370 account is sufficiently pre-funded to cover any and all anticipated/possible transactions that may occur over a given period (e.g., full business day, weekend, banking holiday, etc.)

FIG. 6 is a flow process chart showing another implementation 600 of the systems and methods presented. In FIG. 6, implementation 600 differs from implementation 500 in that Sender 110 is linked to Service Provider 360 (via, e.g., a user-interface, a telephone or mobile prompt, a customer service agent, etc.) to provide or receive instructions on how to complete the money transfer transaction. In one embodiment, Service Provider 360 may stage the transaction between all of the parties and provide Sender 110 a means (e.g., token ID) for identifying the staged transaction at POS 230.

FIG. 7 is a flow process chart illustrating yet another implementation 700 of the systems and methods presented. In FIG. 7, implementation 700 differs from implementation 500 in that Sender 110 is linked directly to Money Transmitter 140 (via, e.g., a user-interface, a telephone or mobile prompt, a customer service agent, etc.) to provide or receive instructions on how to complete the money transfer transaction. In one embodiment, for example, Money Transmitter 140 maintains a call center wherein Sender 110 may call in and request initiation of the transaction. Money Transmitter 140 then stages the transaction, provides Sender 110 with transaction instructions, and provides Service Provider 360 with access to (or a copy of) the staged transaction database. Money Transmitter 140 may also provide (directly or indirectly) Sender 110 with a token ID for presentment at POS 230. As such, when Sender 110 presents an initiation payment and a token ID at POS 230, the token ID is identified at the POS terminal, and the transaction is routed through Service Provider 360, whom confirms that the presentment data/information matches the staged transaction instructions.

In one embodiment, Service Provider 360 requests a clave from Money Transmitter 140, and routes the clave to Sender 110 via POS 230. Said clave is ultimately provided to Recipient 120, who redeems the fulfillment payment from Money Transmitter 140 by providing said clave to Money Transmitter 140. After the fulfillment payment has been distributed to Recipient 120, Service Provider 360 instructs Escrow 370 to provide a funding payment to Money Transmitter 140, and Service Provider (either directly or indirectly via POS 230) provides a replenish payment to Escrow 370.

The above described “notifications” and “instructions” may occur through various ways/means. For example, notifications and instructions may occur by an API call/link, e-mail, text message, or equivalents thereof. Notifications and instructions may also include a communication asking the money transmitter if the transaction is still valid (e.g., the transaction has not expired; there is sufficient funds/resources to complete the transaction; the payment amount(s) is still satisfactory; the money transmitter still wants to complete the transaction(s)). Notifications and instructions may also include a communication with the POS and/or sender to reconfirm the money transmitter's validation of the transaction.

It is noted that the figures (e.g., FIGS. 1-7), individually and/or collectively, serve as embodiments of the presented systems and methods. Each individual process or sub-process performed within the embodiments described can be performed by one or more parties, as well as one or more computer systems. For example, in one embodiment, some or all of the communications and data transfers between money transmitter, service provider, escrow, and POS terminal are performed via an automated computer-based system, such as an API link. Further, not all of the individual process or sub-process described are necessary for implementing the systems and methods described herein. As such, the embodiments presented in the figures (e.g., FIGS. 1-7) are not intended to be limiting.

### Additional Embodiments

In another embodiment, there is provided a computerized method of performing a money transfer transaction. The computerized method includes: (a) staging a money transfer transaction in a database; (b) receiving presentment data, via an application programming interface, indicating that a sender has provided an initiation payment at a point-of-service; (c) providing a computerized notification to a money transmitter, instructing the money transmitter to provide a fulfillment payment to a recipient; and (d) providing a computerized notification to an escrow service, instructing the escrow service to provide a funding payment to the money transmitter. The method may further include: (e) settling the money transfer transaction by providing a computerized instruction to the point-of-service, instructing the point-of-service to provide a replenish payment to the escrow service; (f) tokenizing the money transfer transaction by linking the staged transaction of step (a) to a token ID, wherein the token ID may be provided to the sender for the presentment of the initiation payment; (g) providing the point-of-service with an application programming interface, such that the point-of-service can confirm that the sender has presented the token ID and provided the initiation payment to the point-of-service; and/or (h) pre-funding the escrow service with a transfer balance. The staging of the money transfer transaction may include maintaining a database linking the sender to a token ID. The staging of the money transfer transaction may also include maintaining a database linking the transaction to a token ID. The token ID may be provided to the recipient, and the token ID is used to confirm that the recipient is entitled to the fulfillment payment. The token ID may be provided to the sender in a form selected from the group consisting of: a paper printout, a transaction card, a printed barcode, a pin number, a programmed near-field communication chip, a mobile device prompt, a mobile device barcode, an e-mail, an account number, a pin number, a quick response code, and any combination or equivalent thereof.

In still another embodiment, there is provided a system for conducting a money transfer transaction, comprising: (a) a point-of-service terminal receiving an initiation payment from a sender; (b) a pre-funded escrow account linked to the point-of-service terminal and receiving replenish payments from the point-of-service terminal; (c) a money transmitter terminal linked to the escrow account to receive a funding payment from the escrow account and to provide a fulfillment payment to a recipient; and (d) a centralized service provider linked to the point-of-service terminal, the pre-funded escrow, and the money transmitter. The centralized service provider (1) receives presentment data, via an application programming interface, indicating that the sender has provided the initiation payment at the point-of-service terminal; (2) provides a computerized notification to the money transmitter, instructing the money transmitter to provide the fulfillment payment to the recipient; and (3) provides a computerized notification to the escrow account, instructing the escrow account to provide the funding payment to the money transmitter. The centralized service provider may also stage the money transfer transaction in a database. The centralized service provider may also provide a computerized instruction to the point-of-service terminal, instructing the point-of-service terminal to provide a replenish payment to the escrow account.

In yet another embodiment, there is provided a computerized method of performing a money transfer transaction, the method comprising: (a) staging a money transfer transaction in a database; (b) receiving presentment data, via an application programming interface, indicating that a sender has provided an initiation payment at a point-of-service; (c) providing a computerized notification to a money transmitter, instructing the money transmitter to provide a fulfillment payment to a recipient from a pre-funded account; and (d) settling the money transfer transaction by providing a replenish payment to the pre-funded account. The staging of the money transfer transaction may include maintaining a database linking the sender to a token ID. The staging of the money transfer transaction may include maintaining a database linking the transaction to a token ID. The method may further include: tokenizing the money transfer transaction by linking the staged transaction of step (a) to a token ID, wherein the token ID is provided to the sender for the presentment of the initiation payment. The method may further include: providing the point-of-service with an application programming interface, such that the point-of-service can confirm that the sender has presented the token ID and provided the initiation payment to the point-of-service. The token ID may be provided to the recipient, and the token ID is used to confirm that the recipient is entitled to the fulfillment payment. The token ID may be provided to the sender in a form selected from the group consisting of: a paper printout, a transaction card, a printed barcode, a pin number, a programmed near-field communication chip, a mobile device prompt, a mobile device barcode, an e-mail, an account number, a pin number, a quick response code, and any combination or equivalent thereof.

### Computer Implementation.

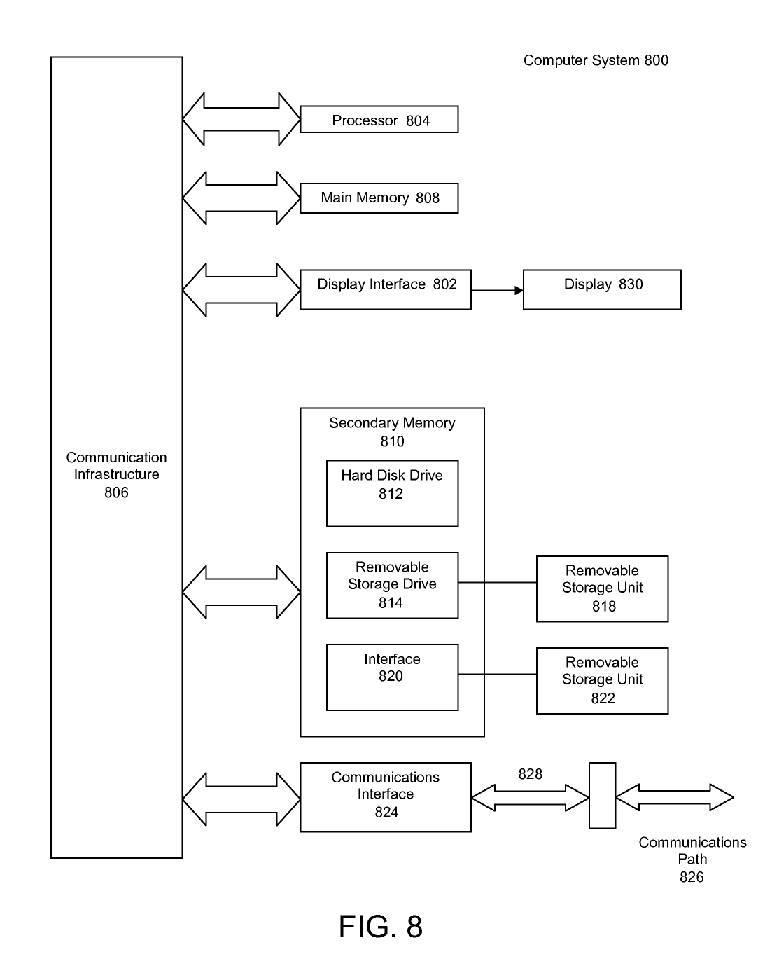

In one embodiment, the invention is directed toward one or more computer systems capable of carrying out the functionality described herein. For example, FIG. 8 is a schematic drawing of a computer system 800 used to implement the methods presented above. Computer system 800 includes one or more processors, such as processor 804. The processor 804 is connected to a communication infrastructure 806 (e.g., a communications bus, cross-over bar, or network). Computer system 800 can include a display interface 802 that forwards graphics, text, and other data from the communication infrastructure 806 (or from a frame buffer not shown) for display on a local or remote display unit 830.

Computer system 800 also includes a main memory 808, such as random access memory (RAM), and may also include a secondary memory 810. The secondary memory 810 may include, for example, a hard disk drive 812 and/or a removable storage drive 814, representing a floppy disk drive, a magnetic tape drive, an optical disk drive, flash memory device, etc. The removable storage drive 814 reads from and/or writes to a removable storage unit 818. Removable storage unit 818 represents a floppy disk, magnetic tape, optical disk, flash memory device, etc., which is read by and written to by removable storage drive 814. As will be appreciated, the removable storage unit 818 includes a computer usable storage medium having stored therein computer software, instructions, and/or data.

In alternative embodiments, secondary memory 810 may include other similar devices for allowing computer programs or other instructions to be loaded into computer system 800. Such devices may include, for example, a removable storage unit 822 and an interface 820. Examples of such may include a program cartridge and cartridge interface (such as that found in video game devices), a removable memory chip (such as an erasable programmable read only memory (EPROM), or programmable read only memory (PROM)) and associated socket, and other removable storage units 822 and interfaces 820, which allow computer software, instructions, and/or data to be transferred from the removable storage unit 822 to computer system 800.

Computer system 800 may also include a communications interface 824. Communications interface 824 allows computer software, instructions, and/or data to be transferred between computer system 800 and external devices. Examples of communications interface 824 may include a modem, a network interface (such as an Ethernet card), a communications port, a Personal Computer Memory Card International Association (PCMCIA) slot and card, etc. Software and data transferred via communications interface 824 are in the form of signals 828 which may be electronic, electromagnetic, optical or other signals capable of being received by communications interface 824. These signals 828 are provided to communications interface 824 via a communications path (e.g., channel) 826. This channel 826 carries signals 828 and may be implemented using wire or cable, fiber optics, a telephone line, a cellular link, a radio frequency (RF) link, a wireless communication link, and other communications channels.

In this document, the terms “computer-readable storage medium,” “computer program medium,” and “computer usable medium” are used to generally refer to media such as removable storage drive 814, removable storage units 818, 822, data transmitted via communications interface 824, and/or a hard disk installed in hard disk drive 812. These computer program products provide computer software, instructions, and/or data to computer system 800. These computer program products also serve to transform a general purpose computer into a special purpose computer programmed to perform particular functions, pursuant to instructions from the computer program products/software. Embodiments of the present invention are directed to such computer program products.

Computer programs (also referred to as computer control logic) are stored in main memory 808 and/or secondary memory 810. Computer programs may also be received via communications interface 824. Such computer programs, when executed, enable the computer system 800 to perform the features of the present invention, as discussed herein. In particular, the computer programs, when executed, enable the processor 804 to perform the features of the presented methods. Accordingly, such computer programs represent controllers of the computer system 800. Where appropriate, the processor 804, associated components, and equivalent systems and sub-systems thus serve as “means for” performing selected operations and functions. Such “means for” performing selected operations and functions also serve to transform a general purpose computer into a special purpose computer programmed to perform said selected operations and functions.

In an embodiment where the invention is implemented using software, the software may be stored in a computer program product and loaded into computer system 800 using removable storage drive 814, interface 820, hard drive 812, or communications interface 824. The control logic (software), when executed by the processor 804, causes the processor 804 to perform the functions and methods described herein.

In another embodiment, the methods are implemented primarily in hardware using, for example, hardware components such as application specific integrated circuits (ASICs) Implementation of the hardware state machine so as to perform the functions and methods described herein will be apparent to persons skilled in the relevant art(s). In yet another embodiment, the methods are implemented using a combination of both hardware and software.

Embodiments of the invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact result from computing devices, processors, controllers, or other devices executing firmware, software, routines, instructions, etc.

For example, in one embodiment, there is provided a computer-readable storage medium, having instructions executable by at least one processing device that, when executed, cause the processing device to: (a) stage a money transfer transaction in a database; (b) receive presentment data, via an application programming interface, indicating that a sender has provided an initiation payment at a point-of-service; (c) send a computerized notification to a money transmitter, instructing the money transmitter to provide a fulfillment payment to a recipient; and (d) send a computerized notification to an escrow service, instructing the escrow service to provide a funding payment to the money transmitter. The computer-readable storage medium may further comprise instructions executable by at least one processing device that, when executed, cause the processing device to: (e) settle the money transfer transaction by sending a computerized instruction to the point-of-service, instructing the point-of-service to provide a replenish payment to the escrow service; (f) tokenize the money transfer transaction by linking the staged transaction to a token ID, wherein the token ID is provided to the sender for the presentment of the initiation payment; and/or (g) provide the point-of-service with an application programming interface, such that the point-of-service can confirm that the sender has presented the token ID and provided the initiation payment to the point-of-service. The money transfer transaction may be staged by linking the sender to a token ID. The money transfer transaction may also be staged by linking the transaction to a token ID. The token ID may be provided to the recipient, and the token ID may be used to confirm that the recipient is entitled to the fulfillment payment. The token ID may be provided to the sender in a form selected from the group consisting of: a printout slip, a transaction card, a printed barcode, a pin number, a programmed near-field communication chip, a mobile device prompt, a mobile device barcode, an e-mail, an account number, a pin number, a quick response code, and any combination or equivalent thereof.

### CONCLUSION

The foregoing description of the invention has been presented for purposes of illustration and description. It is not intended to be exhaustive or to limit the invention to the precise form disclosed. Other modifications and variations may be possible in light of the above teachings. The embodiments were chosen and described in order to best explain the principles of the invention and its practical application, and to thereby enable others skilled in the art to best utilize the invention in various embodiments and various modifications as are suited to the particular use contemplated. It is intended that the appended claims be construed to include other alternative embodiments of the invention; including equivalent structures, components, methods, and means.

Unless defined otherwise, all technical and scientific terms used herein have the same meaning as commonly understood by one of ordinary skill in the art to which this invention belongs.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

It is to be appreciated that the Detailed Description section, and not the Summary and Abstract sections, is intended to be used to interpret the claims. The Summary and Abstract sections may set forth one or more, but not all exemplary embodiments of the present invention as contemplated by the inventor(s), and thus, are not intended to limit the present invention and the appended claims in any way.

What is claimed is:

1. A computerized method of performing a money transfer transaction, the method comprising:
(a) staging a money transfer transaction in a database;
(b) receiving presentment data, via an application programming interface, indicating that a sender has provided an initiation payment at a point-of-service;
(c) providing a computerized notification to a money transmitter, instructing the money transmitter to provide a fulfillment payment to a recipient; and
(d) providing a computerized notification to an escrow service, instructing the escrow service to provide a funding payment to the money transmitter.

2. The method of claim 1, further comprising:
(e) settling the money transfer transaction by providing a computerized instruction to the point-of-service, instructing the point-of-service to provide a replenish payment to the escrow service.

3. The method of claim 1, wherein the staging of the money transfer transaction includes maintaining a database linking the sender to a token ID.

4. The method of claim 1, wherein the staging of the money transfer transaction includes maintaining a database linking the transaction to a token ID.

5. The method of claim 1, further comprising:
tokenizing the money transfer transaction by linking the staged transaction of step (a) to a token ID, wherein the token ID is provided to the sender for the presentment of the initiation payment.

6. The method of claim 5, wherein step (b) further comprises:
providing the point-of-service with an application programming interface, such that the point-of-service can confirm that the sender has presented the token ID and provided the initiation payment to the point-of-service.

7. The method of claim 5, wherein the token ID is provided to the recipient, and the token ID is used to confirm that the recipient is entitled to the fulfillment payment.

8. The method of claim 7, wherein the token ID is provided to the sender in a form selected from the group consisting of: a paper printout, a transaction card, a printed barcode, a pin number, a programmed near-field communication chip, a mobile device prompt, a mobile device barcode, an e-mail, an account number, a pin number, a quick response code, and any combination or equivalent thereof.

9. The method of claim 1, further comprising:
pre-funding the escrow service with a transfer balance.

10. A computer-readable storage medium, comprising:
instructions executable by at least one processing device that, when executed, cause the processing device to
(a) stage a money transfer transaction in a database;
(b) receive presentment data, via an application programming interface, indicating that a sender has provided an initiation payment at a point-of-service;
(c) send a computerized notification to a money transmitter, instructing the money transmitter to provide a fulfillment payment to a recipient; and
(d) send a computerized notification to an escrow service, instructing the escrow service to provide a funding payment to the money transmitter.

11. The computer-readable storage medium of claim 10, further comprising:
instructions executable by at least one processing device that, when executed, cause the processing device to settle the money transfer transaction by sending a computerized instruction to the point-of-service, instructing the point-of-service to provide a replenish payment to the escrow service.

12. The computer-readable storage medium of claim 1, wherein the money transfer transaction is staged by linking the sender to a token ID.

13. The computer-readable storage medium of claim 1, wherein the money transfer transaction is staged by linking the transaction to a token ID.

14. The computer-readable storage medium of claim 1, further comprising:
instructions executable by at least one processing device that, when executed, cause the processing device to tokenize the money transfer transaction by linking the staged transaction to a token ID, wherein the token ID is provided to the sender for the presentment of the initiation payment.

15. The computer-readable storage medium of claim 14, further comprising:
instructions executable by at least one processing device that, when executed, cause the processing device to provide the point-of-service with an application programming interface, such that the point-of-service can confirm that the sender has presented the token ID and provided the initiation payment to the point-of-service.

16. The computer-readable storage medium of claim 14, wherein the token ID is provided to the recipient, and the token ID is used to confirm that the recipient is entitled to the fulfillment payment.

17. The computer-readable storage medium of claim 16, wherein the token ID is provided to the sender in a form selected from the group consisting of: a printout slip, a transaction card, a printed barcode, a pin number, a programmed near-field communication chip, a mobile device prompt, a mobile device barcode, an e-mail, an account number, a pin number, a quick response code, and any combination or equivalent thereof.

18. A system for conducting a money transfer transaction, comprising:
a point-of-service terminal receiving an initiation payment from a sender;
a pre-funded escrow account linked to the point-of-service terminal and receiving replenish payments from the point-of-service terminal;
a money transmitter terminal linked to the escrow account to receive a funding payment from the escrow account and to provide a fulfillment payment to a recipient; and
a centralized service provider linked to the point-of-service terminal, the pre-funded escrow, and the money transmitter, wherein the centralized service provider
(a) receives presentment data, via an application programming interface, indicating that the sender has provided the initiation payment at the point-of-service terminal,
(b) provides a computerized notification to the money transmitter, instructing the money transmitter to provide the fulfillment payment to the recipient, and
(c) provides a computerized notification to the escrow account, instructing the escrow account to provide the funding payment to the money transmitter.

19. The money transfer system of claim 18, wherein the centralized service provider stages the money transfer transaction in a database.

20. The money transfer system of claim 18, wherein the centralized service provider provides a computerized instruction to the point-of-service terminal, instructing the point-of-service terminal to provide a replenish payment to the escrow account.

21. A computerized method of performing a money transfer transaction, the method comprising:
(a) staging a money transfer transaction in a database;
(b) receiving presentment data, via an application programming interface, indicating that a sender has provided an initiation payment at a point-of-service;
(c) providing a computerized notification to a money transmitter, instructing the money transmitter to provide a fulfillment payment to a recipient from a pre-funded account; and
(d) settling the money transfer transaction by providing a replenish payment to the pre-funded account.

22. The method of claim 21, wherein the staging of the money transfer transaction includes maintaining a database linking the sender to a token ID.

23. The method of claim 21, wherein the staging of the money transfer transaction includes maintaining a database linking the transaction to a token ID.

24. The method of claim 21, further comprising:
tokenizing the money transfer transaction by linking the staged transaction of step (a) to a token ID, wherein the token ID is provided to the sender for the presentment of the initiation payment.

25. The method of claim 24, wherein step (b) further comprises:
providing the point-of-service with an application programming interface, such that the point-of-service can confirm that the sender has presented the token ID and provided the initiation payment to the point-of-service.

26. The method of claim 24, wherein the token ID is provided to the recipient, and the token ID is used to confirm that the recipient is entitled to the fulfillment payment.

27. The method of claim 26, wherein the token ID is provided to the sender in a form selected from the group consisting of: a paper printout, a transaction card, a printed barcode, a pin number, a programmed near-field communication chip, a mobile device prompt, a mobile device barcode, an e-mail, an account number, a pin number, a quick response code, and any combination or equivalent thereof.
